(19) United States
(12) Patent Application Publication
(10) Pub. No.: US 2025/0257948 A1
(43) Pub. Date: Aug. 14, 2025

(54) DOSING APPARATUS

(71) Applicant: MAHLE INTERNATIONAL GMBH, Stuttgart (DE)

(72) Inventors: Dirk ANDRITTER, Kirchheim am Neckar (DE); Richard BRÜMMER, Stuttgart (DE); Klaus HASSDENTEUFEL, Gerlingen (DE); Gunther HENTSCHEL, Uhingen (DE); Oliver SIEWERS, Gerlingen (DE); Thomas STRAUSS, Notzingen (DE)

(21) Appl. No.: 18/808,564

(22) Filed: Aug. 19, 2024

(30) Foreign Application Priority Data
Aug. 22, 2023 (DE) 102023207997.6

(51) Int. Cl. F28D 3/04; F28D 21/00; H01M 8/04007; H01M 8/04029

(52) U.S. Cl. CPC F28D 3/04; H01M 8/04029; H01M 8/04074; F28D 2021/0091; H01M 2250/20

(57) ABSTRACT

A dosing apparatus distributing a coolant on a radiator, which has at least one supply line for transporting the coolant, in which there is at least one nozzle for distributing the coolant on the radiator is provided. The nozzles are designed to distribute the coolant in a laminar stream.

### CROSS-REFERENCE TO RELATED APPLICATIONS

This application claims priority from German Patent Application No. DE 10 2023 207 997.6, filed on Aug. 22, 2023, the entirety of which is hereby incorporated by reference herein.

The present invention relates to a dosing apparatus with which a coolant is distributed on a radiator with at least supply line for transporting the coolant as set forth in the preamble of claim 1. The invention also relates to a cooling apparatus for a fuel cell system that has a radiator through which air can flow and an upstream dosing apparatus of this type. The invention also relates to a fuel cell system that has a fuel cell and a cooling apparatus of this type.

DE 10 2017 209 735 A1 discloses a dosing apparatus of this type for distributing a coolant on a radiator, which has at least one supply line for transporting the coolant, in which the supply line has at least one nozzle for distributing the coolant on the radiator. The dosing apparatus also has a grid structure surrounding the radiator in which the at least one supply line is integrated. There is also at least one dosing region in the grid structure for distributing the coolant on the radiator. A sturdy and reliable means for distributing a coolant on a radiator block is to be obtained in this manner.

DE 2017 002 741 A1 discloses a fuel cell vehicle that has a cooling system for at least one fuel cell comprising a heat exchanger and a device for supplying water to the heat exchanger. There is also a condenser in the exhaust air and/or gas from the fuel cell which supplies the water. The condenser has a housing with a grid or screen through which the humid exhaust air and/or gas flows, and there is a collecting area beneath the grid or screen where the condensation water accumulates, which is connected by at least one condensation line to a reservoir with which the water is conducted to the heat exchanger.

DE 10 2016 106 919 A1 discloses a method for spraying a fluid onto an intercooler in a motor vehicle.

DE 10 2010 036 502 A1 discloses a cooling apparatus for increasing the cooling effect of a radiator for a motor vehicle that has a spray nozzle which is placed upstream of the radiator in an air channel such that the water sprayed by the nozzle can be mixed with the air prior to reaching the radiator. A short-term increase in cooling capacity is to be obtained in a simple manner therewith.

DE 10 2008 051 368 A1 discloses a cooling system for transferring heat from a heat source to heatsink formed by an air flow, which has a closed coolant circuit and an evaporation stage.

Other cooling apparatuses that have spray functions for increasing the cooling capacity of a radiator are disclosed in U.S Pat. Nos. 5,101,775 A, 6,298,809 B1, DE 23 58 631 A1, U.S Pat. Nos. 4,771,822 A, 4,215,753, DE 197 37 926 A1, KR 100634870 B1 and FR 2 833 803 A1.

In comparison with conventional motor cooling in a piston engine, cooling a fuel cell is much more difficult because even at low temperatures much more energy must be discharged through the coolant. Even when just slightly above the maximum temperature, severe damages may occur. For the same level of performance, a vehicle powered by a fuel cell is liable to discharge as much as twice the heat through the radiator. In conjunction with the necessity of a lower coolant temperature by ca. 10 to 15 K, this increases in performance could only conceivably be obtained with a great deal of difficulty by using a larger radiator.

An increase in the cooling capacity through the use of stronger cooling airflows requires much more power from a ventilator. A mechanical ventilator drive obtained with the crankshaft is impossible in fuel cell vehicles, thus requiring electric motors which would then consume more electricity, therefore reducing the available battery capacity, or travel range of the vehicle.

In both cases, limited installation space, vehicle safety, weight, design and costs severely limit the possibilities with which these problems can be solved in passenger automobiles and in trucks.

It is also clear from the prior art that distributing water on the radiator can increase the cooling capacity, either through the direct cooling effect of the water (irrigation), or through evaporative cooling, or through both.

The water is normally distributed on the surface of the radiator with an irrigation grid, resulting in water droplets accumulating on the surface thereof.

The disadvantage with this is that this accumulation of water droplets is largely due to surface effects, e.g. the material forming a drip tube, surface treatment and contamination, which can result in the drops first flowing along any downward-sloping parts of the tube and then collecting in areas prone to corrosion, where they are then precipitated. This also results in an increased inhomogeneity in the water accumulation, which can result in losses during evaporation.

The present invention therefore addresses the problem of creating a better, or at least alternative, design for a dosing apparatus of this type, with which the disadvantages of the prior art can be resolved.

This problem is solved according to the invention by the subject matter of the independent claim 1. Advantageous embodiments are the subject matter of the dependent claims.

The present invention is based on the general idea of, instead of distributing coolant in the form of droplets, which results in the disadvantage described above, distributing the coolant on the radiator in the form of a laminar stream, without increasing the local distribution rate in relation to the prior art. This is obtained with the dosing apparatus according to the invention using a nozzle with an appropriate diameter. This dosing apparatus for distributing coolant on a radiator, has at least one supply line for the coolant, which has at least one, preferably numerous, nozzles for distributing/depositing the coolant. A laminar distribution of coolant can thus be obtained with the dosing apparatus according to the invention, resulting in an optimal cooling effect.

In an advantageous design of the invention, the diameter of at least one, preferably all of the nozzles, is determined with the following formula:

$$d = \sqrt{( \frac{4 \dot{V}}{ξ} \cdot \sqrt{\frac{ρ}{Δ p}} )}$$

where:
the discharge coefficient is 0.5<ξ<0.75
the density of the vaporized water is ρ
the pressure range at the nozzle Δp is ca. 30-200 mbar
the discharge of vaporized water/time (for each nozzle) \dot{V}=0.08-0.2 ml/s.

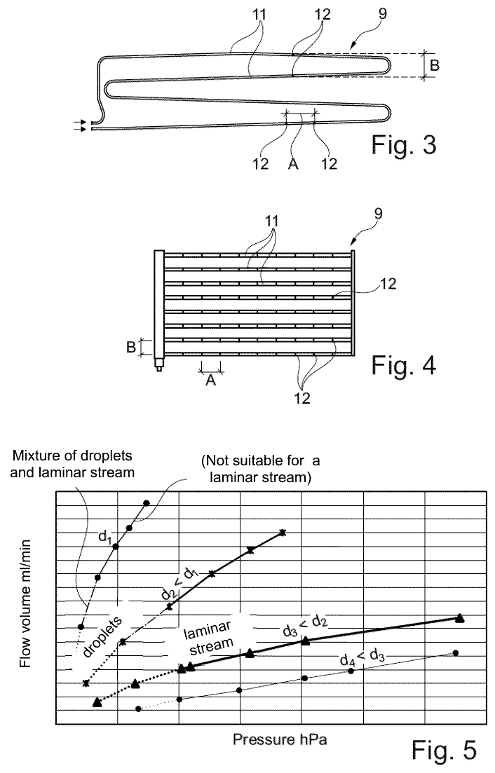

A nozzle with this diameter has major advantages in that the water discharge is basically independent of the aforementioned factors acting on the surface tension, such as the material used to make the droplet tube, surface treatment and/or contamination. Vulnerability to outer acceleration effects that occur with droplets, i.e. by irrigating the radiator with coolant/water through sprinkling, is also essentially eliminated. It is also no longer necessary to balance geodesic pressures between individual droplet tubes with regulators for example. Consequently, the dosing apparatus can be obtained with very few components and therefore not only makes efficient use of resources, but is also extremely cost-effective. In comparison with spraying, where the water that cools the radiator is distributed as a mist instead of in droplets, much less energy is needed to distribute the water. The pressures necessary for this depend on the design of the supply line, ranging from 30-70 mbar in the embodiment shown in FIG. 4, and from 50-200 mbar with the meandering supply line in FIG. 3.

With a meandering supply line, the diameter of the line is of particular importance, because pressure losses must be limited therein to maintain the pressure at the entrances to the nozzles. An inner diameter of the supply line of 4-8 mm, depending on the number of nozzles, has proven to be advantageous. Depending on the pressure drop in the supply line and the geodesic height, the diameter of the nozzles can also vary and be adjusted to current pressure levels. It is therefore relatively simple to calculate the diameter d of the nozzles based on the flow volume, geodesic height and pressure loss in the line. This diameter d of the nozzles will always result in a laminar stream, even when the operating point is altered by external effects.

In an advantageous design of the dosing apparatus according to the invention, the diameter d ranges from 0.2 mm-0.4 mm. This results in irrigation quantities with which optimal cooling and complete evaporation are obtained.

In another advantageous embodiment of the dosing apparatus according to the invention, the supply line has at least two nozzles with a horizontal spacing A of 9 mm to 40 mm, which is preferably adjusted to spacing between rows of tubes in the downstream radiator, or is a multiple of the spacing between rows of tubes. This reliably prevents overlapping of the water exiting adjacent nozzles even under external effects arising during actual operation of the vehicle, such that there are no areas that are subjected to twice the water by adjacent nozzles. This results in an optimal cooling with less water consumption.

The dosing apparatus ideally has two supply lines, placed one above the other, each of which has at least one nozzle, with a vertical spacing B of 30 mm-100 mm between nozzles in different supply lines. This means that there is a vertical spacing B of 30 mm to 100 mm between a nozzle in the upper line and the corresponding nozzle in the lower line. The nozzles in the two supply lines are ideally offset such that the vaporized water is evenly distributed on all of the rows of tubes in the downstream radiator. This also reliably prevents twice the amount of water being distributed to the same area by two nozzles in different supply lines, thus resulting in an optimal cooling with lower water consumption.

In another advantageous embodiment of the dosing apparatus according to the invention, at least one nozzle is formed in the supply line without conventional machining methods, e.g. using lasers. With lasers, in which enough energy is focused in an area in the workpiece to melt and vaporize it, it not problematic to produce the normally optimal diameter d of 0.2 mm-0.4 mm for the dosing apparatus according to the invention. These small diameters are extremely difficult to obtain with normal machining methods, whereas drilling with lasers is a reliable, precise and inexpensive solution.

In a simple embodiment, the laminar stream exiting the nozzles is orthogonal to the downstream radiator block. In a particularly advantageous embodiment, the supply line has two nozzles on a circumferential section spaced apart at an angle a of 65° to 85°, preferably 70° to 80°, and particularly preferably at an angle a of approx. 75°. The axis of the supply line is orthogonal to the radius, or the radial plane in which the two nozzles are formed. The central axis between the two nozzles is then orthogonal to the cooling plane. At these angles, it is possible to distribute coolant, e.g. condensation water from a fuel cell, on a relatively large surface area of the radiator with a single supply line, with no overlapping from two adjacent nozzles. A circumferential section refers to a cross section of the typically round supply line where the at least two nozzles are placed. Placing at least two nozzles on a circumferential section of the supply line has the major advantage that the turbulence obtained in the coolant exiting the nozzles, e.g. water, can be enhanced by the air flowing through it, thus resulting in a higher cooling capacity. The nozzles can point upward and downward on the supply line at the same circumferential section, or they can point in alternating directions over the length of the supply line.

The present invention is also based on the general concept of creating a cooling apparatus for a fuel cell system that has a radiator through which air flows and an upstream dosing apparatus such as that described above. The individual nozzles in the at least one supply line in the dosing apparatus are pointed toward the surface of the downstream radiator, such that no water has to be discharged against the airflow. Instead, the air flowing around the supply line carries the water/coolant exiting the line and facilitates its movement toward the surface of the radiator.

The present invention is also based on the general concept of creating a fuel cell system for a fuel cell vehicle that has a fuel cell, a cooling apparatus such as that described in the preceding paragraph, and a condenser in the exhaust gas and/or air system for the fuel cell, which provides at least part of the water for the cooling apparatus. This results in a fuel cell vehicle with which the necessary cooling capacity can be obtained on an extremely individual basis, adjusted to the specific needs, based on the amount of water that is distributed onto the surface of the radiator by the dosing apparatus for the cooling apparatus according to the invention. Moreover, the radiator for the cooling apparatus can be kept relatively small, because it is possible to distribute water onto the radiator with the dosing apparatus when it needs to be cooled to a greater extent for short periods of time. With a smaller radiator, it is possible to reduce not only costs, but also weight, which has positive long-term effects on the distance that the fuel cell vehicle can travel.

Other important features and advantages of the invention can be derived from the dependent claims, drawings, and associated descriptions thereof.

It is understood that the features specified above and described below can be used not only in the given combinations, but also in other combinations or in and of themselves without abandoning the scope of the invention defined by the claims. Components of higher level units specified above and below, e.g. a mechanism, device or assembly, that are indicated separately, can form separate components of this unit or be integral parts thereof, even if the drawings indicate otherwise.

Preferred exemplary embodiments of the invention are shown in the drawings, and shall be explained in greater detail below, in which the same reference symbols are used for the same, similar, or functionally identical components.

Therein, schematically:

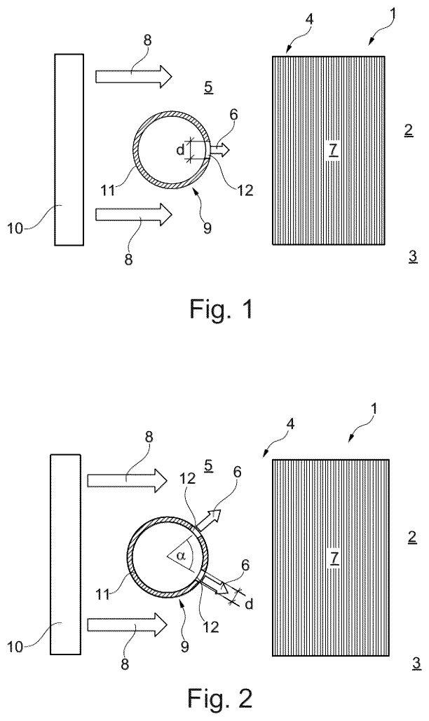

FIG. 1 shows a sectional view of a cooling apparatus according to the invention for a fuel cell system according to the invention in a fuel cell vehicle that has the dosing apparatus according to the invention,

FIG. 2 shows a similar illustration to that in FIG. 1, but with a supply line for the dosing apparatus that has two nozzles located on a circumferential section,

FIG. 3 shows a possible embodiment of a meandering supply line,

FIG. 4 shows a dosing apparatus that has numerous supply lines placed one above the other, and

FIG. 5 shows a graph illustrating the volumetric flow as a function of the pressure with nozzles of different diameters in the dosing apparatus according to the invention.

As FIGS. 1-4 show, the fuel cell system 1 according to the invention in a fuel cell vehicle 2, not otherwise shown, contains a fuel cell 3, cooling apparatus 4, and condenser 5, which is in the exhaust gas and/or air system for the fuel cell 3, and provides at least part of the water forming the coolant 6 for the cooling apparatus 4. The cooling apparatus 4 has a radiator 7, in particular a coolant radiator through which air can flow, with an upstream dosing apparatus 9 according to the invention. There is a ventilator 10 for conveying the air 8. The fuel cell 3 and condenser 5 are merely indicated by their reference numerals in the drawings, and can also be located elsewhere, e.g. above or below the drawing plane.

The dosing apparatus 9 is used to distribute the coolant 6, water in this case, on the radiator 7, or the surface thereof, and has at least one supply line 11 with which the coolant 6 is transported. The at least one supply line 11 has at least one nozzle 12 (see FIG. 1), or at least two nozzles 12 (see FIG. 2) with which the coolant is distributed on the radiator 7. Instead of the prior art approach of distributing the coolant in the form of droplets, the diameter d of the nozzles 12 in the supply line 11 is such that, to obtain an optimal cooling effect, the coolant 6, i.e. water, exits the nozzles 12 in a laminar stream, without needing to increase the amount of water in relation to the prior art. It may be advantageous to adjust the diameter d of the nozzles 12 to compensate for losses in the supply lines 11 and the geodesic pressure, thus obtaining a fundamentally constant distribution of the coolant.

The diameter d of the nozzles can be calculated with the following formula:

$$d = \sqrt{( \frac{4 \dot{V}}{ξ} \cdot \sqrt{\frac{ρ}{Δ p}} )}$$

where:
the discharge coefficient is 0.5<ξ<0.75
the density of the vaporized water is ρ
the pressure range at the nozzle Δp is ca. 30-200 mbar
the discharge of vaporized water/time (for each nozzle) \dot{V}=0.08-0.2 ml/s.

A nozzle 12 with this diameter d has major advantages that are basically independent of factors acting on the surface that normally affect surface tensions, such as the material used to make the supply line 11, surface treatment or contamination. Vulnerability to outer acceleration effects that occur with droplets is also essentially eliminated with the dosing apparatus 9 according to the invention. It is also no longer necessary to balance geodesic pressures between individual supply lines 11 using regulators for example. Consequently, the dosing apparatus 11 according to the invention can be obtained with very few components and therefore not only makes efficient use of resources, but is also extremely cost-effective. In comparison with spraying, where the water that cools the radiator is distributed as a mist instead of in droplets, much less energy is needed to distribute the water. The pressures necessary for this depend on the design of the supply line, ranging from 20-120 mbar.

The at least one nozzle 12 can also be designed such that the coolant exits in a laminar stream with an average flow rate of 1 m/s-2.5 m/s, with the diameter d of the nozzle (12) being such that the Reynolds number Re is between 300 and 1,800.

$$d ( Re ) = \frac{4 \dot{V}}{Re v π}$$

### Where

ν is the kinematic viscosity.

The laminar operating range is clearly defined. With a smaller Re number, droplets are formed, and with a higher Re number, the stream decomposes randomly, resulting in a spray.

The downward slope of at least one supply line 11 can be greater than 2%, simplifying drainage to prevent frost damage. The inner diameter of at least one supply line 11 can be 4 mm to 8 mm.

The diameter d is preferably 0.2 mm to 0.4 mm. This results in an optimal cooling of the radiator 7 while obtaining complete evaporation of the of the water. An optimal cooling is therefore obtained with less water.

FIGS. 1 and 2 show that the nozzles 12 point toward the radiator 7 in substantially the same direction as the air 8, or at an angle thereto. This results in an optimal turbulence in the coolant 6 exiting the nozzles 12 prior to reaching the surface of the radiator 7, thus obtaining an optimal cooling, such that the coolant 6 can be distributed with relatively little pressure.

FIG. 2 shows that the supply line 11 has two nozzles 12 at a circumferential section, which are at an angle α to one another of 65° to 85°, preferably 70° to 80°, particularly preferably at an angle α of ca. 75°. The angle α is shown in the drawing plane, which is perpendicular to the axis of the supply line 11. This further increases the turbulence in the coolant 6 exiting the nozzles 12, and improves the mixture thereof with the air 8. The nozzles 12 can point upward and downward on the supply line 11, as shown in FIG. 2, or they can point in alternating directions over the length of the supply line 11.

The dosing apparatus 9 according to the invention can theoretically have two different hydraulic systems, which are shown in FIGS. 3 and 4. In FIG. 3, a system with a single meandering tube is shown, which typically has four to six bends. The supply line 11 meanders from the entry to the exit without breaks. It can have one entry, into which water enters at the top, or two entries, into which water enters at both the top and bottom, as shown in FIG. 3. To prevent freezing of the coolant 6, i.e. water, still in the supply line when not in use, the supply line can be drained through a lower drain valve.

The pressures needed for this range from 30-70 mbar in the embodiment shown in FIG. 4 and from 50-200 mbar in the supply line shown in FIG. 3.

A dosing apparatus 9 according to the invention is shown in FIG. 4, containing numerous tubes, with an intake on just one side (left). The dosing apparatus 9 in FIG. 4 has eight supply lines 11, placed one above the other, containing numerous nozzles 12.

The formula used in the invention to determine the diameter d of the nozzles 12 can be verified by the graph shown in FIG. 5. The pressure at the nozzles 12 is plotted on the x-axis, and the flow volume through the nozzles 12 is plotted in millimeters per minute on the y-axis. The individual curves represent different diameters d, the largest of which is d₁ and the smallest is d₄. Each of the curves has an initial drip section, indicated by a dotted line, which transitions into a laminar section, indicated by a solid line.

For the given flow volume for each nozzle 12, an optimal diameter d can be found, which always results in a laminar stream, even when the operating point varies due to external effects. In comparison with the drip sections, indicated by broken lines, the curve is flatter there because it is not affected by any external effects acting on the pressure in the supply line 11. The amount of water discharged there, i.e. the flow volume, remains nearly constant. With typical radiator blocks and operating conditions in utility vehicles, the coolant, or water, discharge, at each nozzle 12 ideally ranges from 3-10 ml/minute. Total evaporation can be obtained in this range. The typical diameter d for an optimal water discharge ranges from 0.2 mm to 0.4 mm.

If the supply line 11 has numerous nozzles 12, they should be spaced apart horizontally at a distance A of 0.9 mm to 40.0 mm. If the dosing apparatus 9 has numerous supply lines 11 placed one above the other, each of which has at least one nozzle 12, the vertical spacing B between two nozzles 12 in two adjacent supply lines 11 is between 40 mm and 100 mm. This prevents overlapping of individual laminar streams from different nozzles 12, because a larger surface area is also coated with one stream of water due to external effects arising during actual operation of the vehicle.

In the dosing apparatus 9 shown in FIG. 3, which has a meandering supply line 11, the inner diameter thereof is to be selected such that the flow losses at the entry are no more than 2 to 2.5 times the pressure losses at the nozzles 12. A meandering path over the entire length results in an advantageous pressure distribution, and therefore a uniform coolant discharge. Further homogenization of the pressure at the nozzles 12 can be obtained with a meandering path (see FIG. 3), by adjusting the angle and the spacing to the pressure losses in the supply line 11.

The individual nozzles 12 can be formed without machining, e.g. using lasers, with which the small diameter d between 0.2 and 0.4 mm can be readily obtained. The supply lines 11 can be made of metal, e.g. aluminum, a thermoplastic such as polypropylene, or a composite thereof.

On the whole, a laminar discharge of the coolant 6 can be obtained with the dosing apparatus 9 according to the invention, which contains the nozzles 12 according to the invention, by means of which an optimal cooling of the radiator 7, and therefore a fuel cell 3 in a fuel cell vehicle 2, with extremely low water or coolant consumption.

The specification can be readily understood with reference to the following Representative Paragraphs:
Representative Paragraph 1. A dosing apparatus (9) for distributing a coolant (6) on a radiator (7), which has at least one supply line (11) for transporting the coolant (6), in which there is at least one nozzle (12) for distributing the coolant (6) on the radiator (7), characterized in that the nozzle (12) is designed to discharge the coolant in a laminar stream.
Representative Paragraph 2. The dosing apparatus according to Representative Paragraph 1, characterized in that the diameter d of the nozzles (12) is determined according to the following formula:

$$d = \sqrt{( \frac{4 \dot{V}}{ξ} \cdot \sqrt{\frac{ρ}{Δ p}} )}$$

where:
the discharge coefficient is 0.5<ξ<0.75
the density of the vaporized water is ρ
the pressure range at the nozzle Δp is ca. 30-200 mbar
the discharge of vaporized water/time (for each nozzle) \dot{V}=0.08-0.2 ml/s.
Representative Paragraph 3. The dosing apparatus according to Representative Paragraph 1 or 2, characterized in that at least one nozzle (12) is designed such that the coolant is discharged in a laminar stream with an average flow rate of 1 m/s to 2.5 m/s, wherein the diameter of the nozzle (12) is such that the Reynolds number Re is between 300 and 1,800.

$$d ( Re ) = \frac{4 \dot{V}}{Re v π}$$

where ν is the kinematic viscosity.
Representative Paragraph 4. The dosing apparatus according to any of the preceding Representative Paragraphs, characterized in that the diameter d ranges from 0.2 mm to 0.4 mm.
Representative Paragraph 5. The dosing apparatus according to any of the preceding Representative Paragraphs, characterized in that the supply line (11) has at least two nozzles (12), which are spaced apart horizontally at a distance A of 9.0 mm to 40.0 mm.
Representative Paragraph 6. The dosing apparatus according to any of the preceding Representative Paragraphs, characterized in that the dosing apparatus (9) has two supply lines (11) placed one above the other, each of which has at least two nozzles (12), wherein two nozzles (12) in two of the supply lines (11) are spaced vertically at a distance B of 30.0 mm to 100.0 mm.
Representative Paragraph 7. The dosing apparatus according to Representative Paragraph 6, characterized in that the downward slope of at least one supply line (11) is greater than 2%.
Representative Paragraph 8. The dosing apparatus according to Representative Paragraph 6 or 7, characterized in that the inner diameter of at least one supply line (11) is 4 mm to 8 mm.
Representative Paragraph 9. The dosing apparatus according to any of the preceding Representative Paragraphs, characterized in that the at least one nozzle (12) is formed without machining, in particular with a laser, in the supply line (11).
Representative Paragraph 10. The dosing apparatus according to any of the preceding Representative Paragraphs, characterized in that the supply line (11) has two nozzles (12) at a circumferential section, which are placed at a radial angle α of 65° to 85° to one another.
Representative Paragraph 11. The dosing apparatus according to any of the Representative Paragraphs 1 to 9, characterized in that the supply line (11) has two nozzles (12) at a circumferential section, which are placed at a radial angle α of 70° to 80° to one another.
Representative Paragraph 12. The dosing apparatus according to any of the Representative Paragraphs 1 to 9, characterized in that the supply line (11) has two nozzles (12) at a circumferential section, which are placed at a radial angle α of 75° to one another.
Representative Paragraph 13. A cooling apparatus (4) for a fuel cell system (1) that has a radiator (7) through which air (8) can flow, and an upstream dosing apparatus (9) according to any of the preceding Representative Paragraphs.
Representative Paragraph 14. A fuel cell system (1) for a fuel cell vehicle (2) that has a fuel cell (3), a cooling apparatus (4) according to Representative Paragraph 13, and a condenser (5), which is placed in an exhaust gas/air system for the fuel cell (3), and provides at least part of the coolant (6) for the cooling apparatus (4).

1. A dosing apparatus for distributing a coolant on a radiator, comprising at least one supply line for transporting the coolant, in which there is at least one nozzle for distributing the coolant on the radiator, wherein the nozzle is configured to discharge the coolant in a laminar stream.

2. The dosing apparatus according to claim 1, wherein the diameter d of the nozzles is determined according to the following formula:
$$d = \sqrt{( \frac{4 \dot{V}}{ξ} \cdot \sqrt{\frac{ρ}{Δ p}} )}$$
where:
the discharge coefficient is 0.5<ξ<0.75
the density of the vaporized water is ρ
the pressure range at the nozzle Δp is 30-200 mbar
the discharge of vaporized water/time (for each nozzle) \dot{V}=0.08-0.2 ml/s.

3. The dosing apparatus according to claim 1, wherein the at least one nozzle is configured such that the coolant is discharged in a laminar stream with an average flow rate of 1 m/s to 2.5 m/s, wherein the diameter of the nozzle is such that the Reynolds number Re is between 300 and 1,800.
$$d ( Re ) = \frac{4 \dot{V}}{Re v π}$$
where ν is the kinematic viscosity.

4. The dosing apparatus according to claim 1, wherein the diameter d ranges from 0.2 mm to 0.4 mm.

5. The dosing apparatus according to claim 1, wherein the supply line has at least two nozzles, which are spaced apart horizontally at a distance A of 9.0 mm to 40.0 mm.

6. The dosing apparatus according to claim 1, wherein the dosing apparatus has two supply lines placed one above the other, each of which has at least two nozzles, wherein two nozzles in two of the supply lines are spaced vertically at a distance B of 30.0 mm to 100.0 mm.

7. The dosing apparatus according to claim 6, wherein the downward slope of at least one supply line is greater than 2%.

8. The dosing apparatus according to claim 6, wherein the inner diameter of at least one supply line is 4 mm to 8 mm.

9. The dosing apparatus according to claim 1, wherein the at least one nozzle is formed without machining, in particular with a laser, in the supply line.

10. The dosing apparatus according to claim 1, wherein the supply line has two nozzles at a circumferential section, which are placed at a radial angle α of 65° to 85° to one another.

11. The dosing apparatus according to claim 1, wherein the supply line has two nozzles at a circumferential section, which are placed at a radial angle α of 70° to 80° to one another.

12. The dosing apparatus according to claim 1, wherein the supply line has two nozzles at a circumferential section, which are placed at a radial angle α of 75° to one another.

13. A cooling apparatus for a fuel cell system that has a radiator through which air can flow, and an upstream dosing apparatus according to claim 1.

14. A fuel cell system for a fuel cell vehicle that has a fuel cell, a cooling apparatus according to claim 13, and a condenser, which is placed in an exhaust gas/air system for the fuel cell, and provides at least part of the coolant for the cooling apparatus.

15. The dosing apparatus of claim 2, wherein the supply line has at least two nozzles, which are spaced apart horizontally at a distance A of 9.0 mm to 40.0 mm.

16. The dosing apparatus of claim 2, wherein the dosing apparatus has two supply lines placed one above the other, each of which has at least two nozzles, wherein two nozzles in two of the supply lines are spaced vertically at a distance B of 30.0 mm to 100.0 mm.

17. The dosing apparatus according to claim 2, wherein the supply line has two nozzles at a circumferential section, which are placed at a radial angle α of 65° to 85° to one another.

18. The dosing apparatus according to claim 2, wherein the supply line has two nozzles at a circumferential section, which are placed at a radial angle α of 75° to one another.

19. A cooling apparatus for a fuel cell system that has a radiator through which air can flow, and an upstream dosing apparatus according to claim 2.

20. A fuel cell system for a fuel cell vehicle that has a fuel cell, a cooling apparatus according to claim 19, and a condenser, which is placed in an exhaust gas/air system for the fuel cell, and provides at least part of the coolant for the cooling apparatus.
